(19) United States
(12) Patent Application Publication
(10) Pub. No.: US 2005/0196493 A1
(43) Pub. Date: Sep. 8, 2005

(54) That's my water

(76) Inventor: Preston M. Singer, Canyon Country, CA (US)

Correspondence Address: Preston M. Singer, 15035 Califa St., Van Nuys, CA, 91411, US

(21) Appl. No.: 10/794,873

(22) Filed: Mar. 8, 2004

(51) Int. Cl. A23B 4/00

(52) U.S. Cl. 426/115

(57) ABSTRACT

The purpose of this invention is to allow users of bottled water to identify which bottle is theirs when two or more people are drinking the same bottled water. The water bottles come with a particular cap that has a ⅛″ orifice and is filled with food coloring. The cap is then placed on the water bottle and sealed airtight with a gasket. The cap has a safety seal placed around it and the bottle to avoid mixture prior to usage. The following steps describe how to open and use this invention: Open the bottle by turning the cap counterclockwise, thus breaking the safety seal; Remove the airtight gasket; Install the cap back on the bottle by turning the cap clockwise until airtight; Shake the bottle so the food coloring mixes with the water inside the bottle changing the color of the water in the bottle.

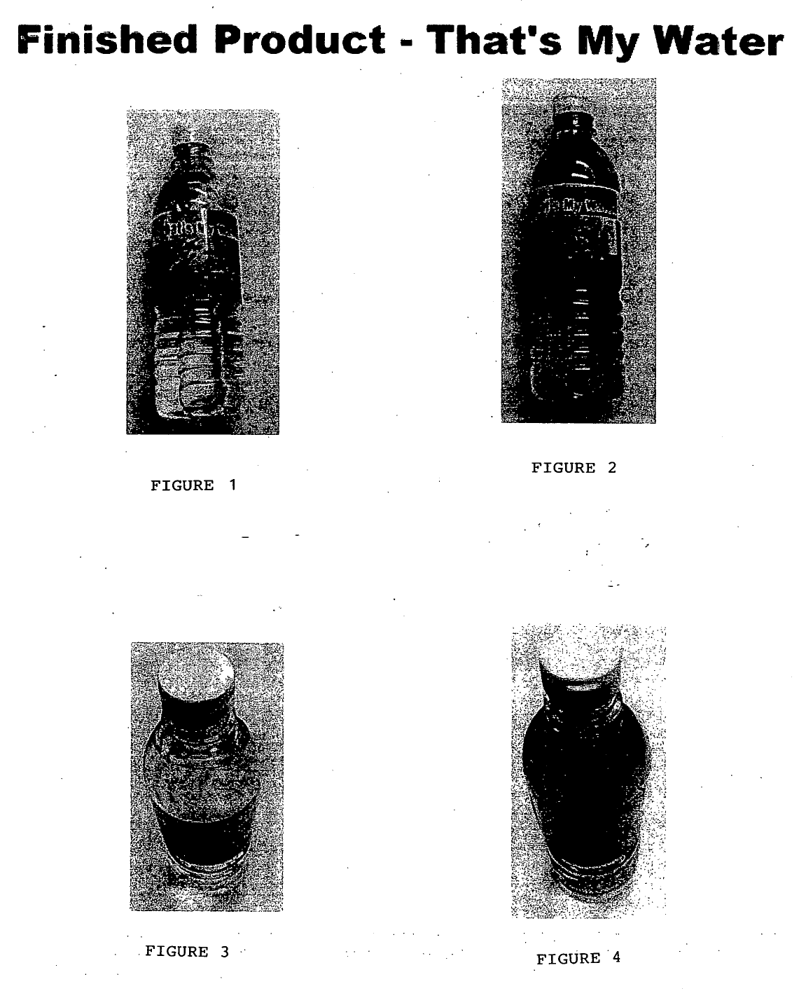

FIG. 1) Front view of finished product fully packaged before activating food coloring.

FIG. 2) Top front view of finished product fully packaged before activating food coloring.

FIG. 3) Front view of finished product after activating food coloring.

FIG. 4) Top front view of finished product after activating food coloring.

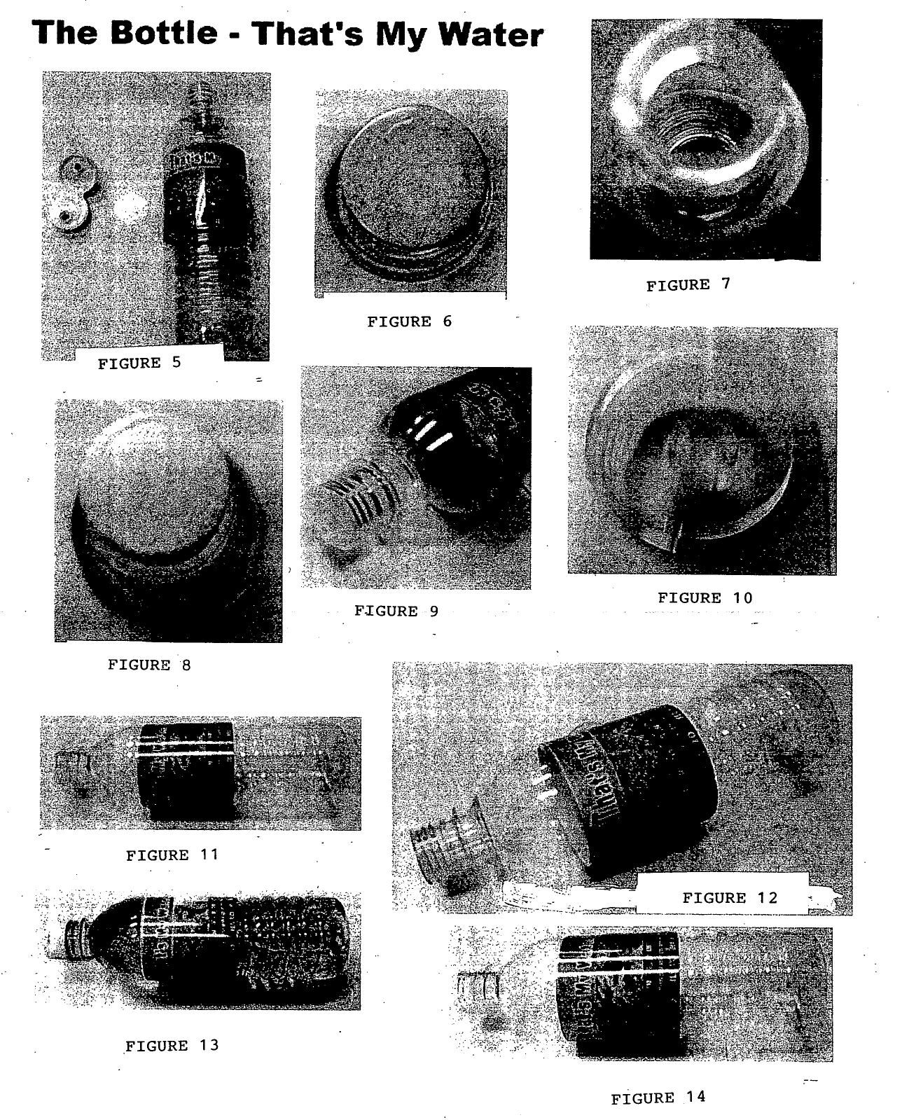

FIG. 5) All components;

FIG. 6) Top view of finished product

FIG. 7) Top view of empty bottle

FIG. 8) Top of bottle with seal

FIG. 9) Side view of bottle with seal

FIG. 10) Bottom of empty bottle

FIG. 11) Side view of empty bottle

FIG. 12) Side view of empty bottle (different angle)

FIG. 13) Side view of finished product with food coloring activated

FIG. 14) Side view of empty bottle (closer view)

FIG. 15) Cap filled with food coloring

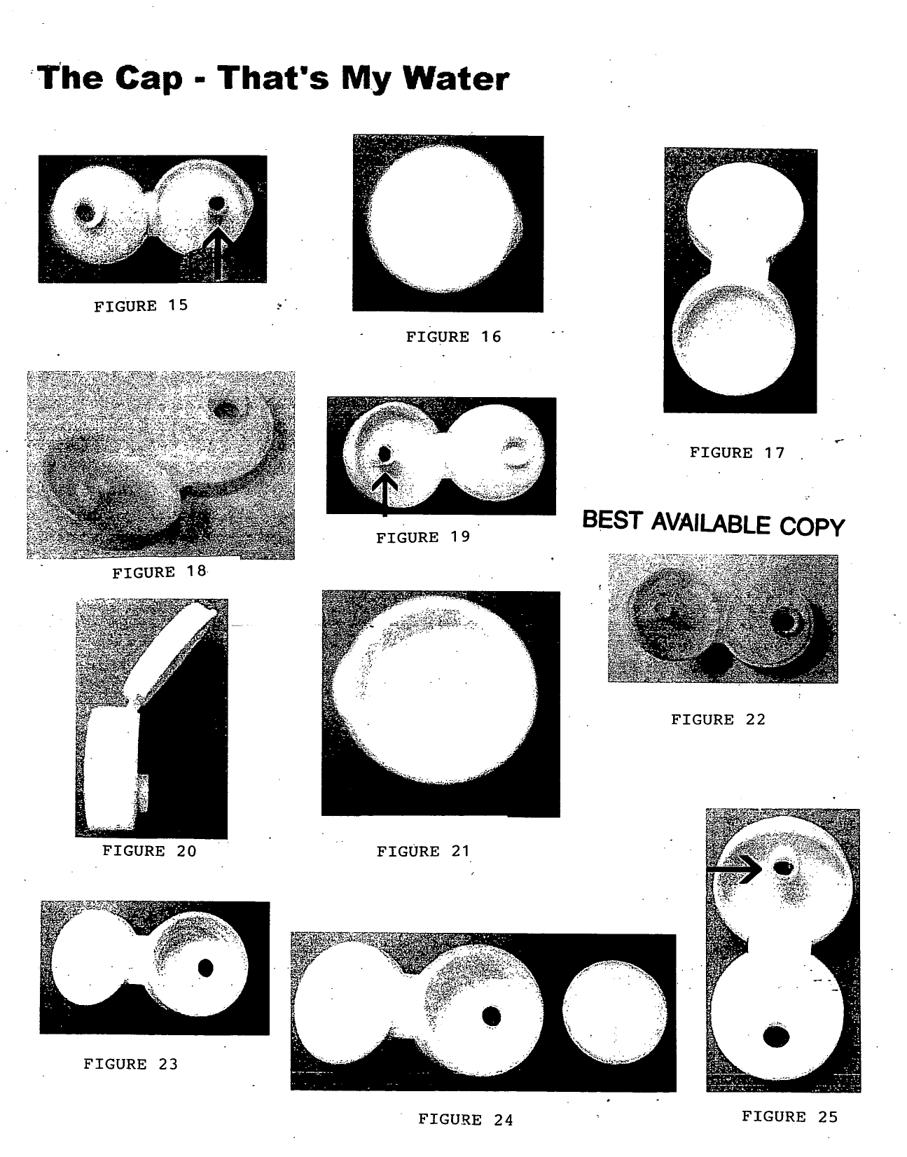

FIG. 16) Lid closed right side up

FIG. 17) Lid opened upside down with seal in place

FIG. 18) Lid opened right-side up

FIG. 19) Cap filled with food coloring;

FIG. 20) Side view of open lid

FIG. 21) Lid closed upside-down with seal in place

FIG. 22) Lid opened right-side up

FIG. 23) Lid open upside-down without seal

FIG. 24) Lid open upside-down with seal

FIG. 25) Cap with food coloring

1. I claim that the cap filled with food coloring, combined with the bottle type, airtight seal, safety seal, and different food coloring used for the purpose of distinguishing each bottle is my invention.
